(19) United States
(12) Patent Application Publication
(10) Pub. No.: US 2019/0196058 A1
(43) Pub. Date: Jun. 27, 2019

(54) Method and System for Modeling in a Subsurface Region

(71) Applicants: Amit Kumar, The Woodlands, TX (US); Yan Zaretskiy, Houston, TX (US)

(72) Inventors: Amit Kumar, The Woodlands, TX (US); Yan Zaretskiy, Houston, TX (US)

(21) Appl. No.: 16/191,528

(22) Filed: Nov. 15, 2018

Related U.S. Application Data
(60) Provisional application No. 62/609,147, filed on Dec. 21, 2017.

(51) Int. Cl. G01V 99/00; E21B 47/10

(52) U.S. Cl. CPC G01V 99/005; G01V 2210/661; E21B 47/10

(57) ABSTRACT

A method and system are described for creating subsurface models that involve the use of different grain sizes for simulating fluid flow in reservoir simulators. The method includes constructing a subsurface model for a subsurface region and using the subsurface model in simulations and in hydrocarbon operations, such as hydrocarbon exploration, hydrocarbon development, and/or hydrocarbon production.

### CROSS REFERENCE TO RELATED APPLICATION

This application claims the priority benefit of U.S. Provisional Application Ser. No. 62/609,147, filed Dec. 21, 2017, the disclosure of which is incorporated herein by reference in its entirety.

### FIELD OF THE INVENTION

This disclosure relates generally to methods and systems for creating subsurface to models, and in particular to subsurface models that simulate the sedimentary deposits by turbidity current(s), which have occurred to form subsurface horizons or surfaces. The methods and systems may include constructing a subsurface model for a subsurface region and using the subsurface model in simulations and in hydrocarbon operations, such as hydrocarbon exploration, hydrocarbon development, and/or hydrocarbon production.

### BACKGROUND

This section is intended to introduce various aspects of the art, which may be associated with exemplary embodiments of the present disclosure. This discussion is believed to assist in providing a framework to facilitate a better understanding of particular aspects of the present invention. Accordingly, it should be understood that this section should be read in this light, and not necessarily as admissions of prior art.

In various hydrocarbon operations it is desirable to have one or more subsurface models of subsurface structures (e.g., hydrocarbon reservoirs). For example, a subsurface model may provide a description of the subsurface structures and material properties of the subsurface region. The subsurface model may represent measured or interpreted data for the subsurface region and may include objects (e.g., horizons, faults, surfaces, volumes, and the like). The subsurface model may also be discretized with a mesh or a grid that includes nodes and forms mesh elements (e.g., voxels or cells) within the model. By way of example, the subsurface model may be created from a structural framework (e.g., organization of objects) and provide defined compartments or subvolumes.

Subsurface models typically comprise one or more of a geomechanical model, a geologic model, or a reservoir model. A geologic model may represent measured or interpreted data for the subsurface region, such as seismic data and well log data. The geologic model may be within a physical space or domain and may have material properties, such as rock properties. A reservoir model may be used to simulate flow of fluids within the subsurface region. Accordingly, the reservoir model may use the same mesh and/or mesh elements as other models, or may resample or upscale the mesh and/or mesh elements to lessen the computations for simulating the fluid flow

Hydrocarbon reservoirs are typically created by a combination of physical, chemical, and biological processes. However, it can be difficult to create a subsurface model that successfully integrates the key mechanisms controlling structure, while maintaining sufficient simplicity to be both computable in reasonable amounts of time as well as comprehensible in terms of the balance of different effects modeled. Subsurface reservoirs are usually formed by the deposition of carbonate and/or siliciclastic materials by a variety of mechanisms, which undergo further physical, chemical, and biological alteration (diagenesis) over geologic time. The ultimate porosity of these media determine their ability to store oil and gas, while their permeability and fracture or faulting structure determine the potential flow paths for fluids, and thus influence the most effective means to develop a reservoir through drilling in order to extract oil and gas. While full modeling of all post-depositional processes over time is often impracticable, some key features that control overall reservoir flow performance are already evident at the time of deposition of the material. Thus, it would be useful to have methods and systems for modeling depositional processes.

For example, hydrocarbon reservoirs may be formed as a result of sedimentary deposits from currents. By way of example, turbidity currents refer to deepwater underflows driven by the density difference between the suspended particles in the current and the ambient fluid. In these currents, the sediment deposited may form hydrocarbon reservoirs, which may involve a variety of regimes. The regimes may utilize a Rouse number, which expresses the ratio of gravitational settling and turbulent mixing. For sediments with small Rouse numbers (Ro) (e.g., Ro less than (<) 0.5), a significant portion of the transport occurs in suspension. However, for sediments with larger Rouse numbers (e.g., Ro greater than (>) 0.5), the transport may be dominated by bedload transport.

For bedload transport, particles typically roll, slide, and saltate. The bedload transport is modeled as a flux of sediment and typically leads to a hyperbolic system of partial differential equations (PDE). As is common for hyperbolic PDEs, the numerical solution procedure must have an upwinded flux treatment for numerical stability. In this treatment, the bedload flux calculation can be performed either in isolation, or in conjunction with other flow variables. Accordingly, various approaches have been used to solve this system of PDEs: for example, decoupled approaches, weakly coupled approaches, and fully coupled approaches have been used.

For example, a decoupled approach may involve computing the bedload flux independent of the flow variables. As such, in this approach, the flow variables are first computed and then utilized to compute the bedload flux. See, for example, Kubatko et al., “An unstructured grid morphodynamic model with a discontinuous Galerkin method for bed evolution”, Ocean Modelling, Vol. 15, pp. 71-89 (2006). However, this approach may lead to unstable simulations in supercritical flow conditions. Supercritical flows refer to flows with Froude number (Fr) greater than unity (Fr>1), where the Froude number is a non-dimensional number expressing the ratio of the inertial and gravitational forces.

As another example, a weakly coupled approach may be used to address the instability. Exemplary weakly coupled approaches are described in Cordier et al., “Bedload transport in shallow water models: Why splitting (may) fail, how hyperbolicity (can) help”, Advances in Water Resources, Vol. 34, pp. 980-989 (2011) and in Juez et al., “A 2D weakly-coupled and efficient numerical model for transient shallow flow and movable bed”, Advances in Water Resources, Vol. 71, pp. 93-109 (2014). In general, a weakly coupled approach is similar to a decoupled approach; however, an additional restriction on the size of the time step is typically enforced based on approximate sediment wave speed information. However, unfortunately, the weakly coupled approach may also be unstable for modeling supercritical flows.

As another example, a fully coupled approach may be used to address the instability. The fully coupled approach may involve solving all of the flow and bed evolution equations simultaneously. For the fully coupled approach, the bedload transport calculations suffer from two main deficiencies. The first deficiency involves the failure to satisfy certain conditions, such as the water-at-rest condition or the no-sediment transport condition depending on the conditions. The first condition, which is water-at-rest, implies that the numerical solution of the PDE should not predict a flow due to numerical errors when the flow in the real system is absent. The second condition, which is no-sediment transport condition, implies that sediment transport in the bedload layer must not happen when the shear stress exerted by the flow on the bed is less than that required for motion for that particular grain size. By way of example, the use of the Harten-Lax-van Leer (HLL) solver does not satisfy the water-at-rest condition, as described in Diaz et al., “High order exactly well-balanced numerical methods for shallow water systems”, Journal of Computational Physics, Vol. 246, p. 242-264 (2013) and Soares-Frazão et al., “HLLC scheme with novel wave-speed estimators appropriate for two-dimensional shallow-water flow on erodible bed”, International Journal for Numerical Methods in Fluids, Vol. 66, pp. 1019-1036 (2011). Additionally, these approaches also do not satisfy the no-sediment transport condition when the shear stress is below the critical shear stress for that sediment size or grain size. Partly because of not satisfying these two important properties, such approaches are also tend to be more diffusive. As such, long time predictions of stratigraphy relevant to the formation of hydrocarbon reservoirs may be erroneous or inaccurate. Further still, other approaches, which may be based on the linearized Roe solver, may satisfy the water-at-rest condition or the no-sediment transport condition, but may become prohibitively expensive for large scale problems due to the need for computing the eigenvectors and eigenvalues of the augmented Jacobian matrix.

The second deficiency of the fully coupled approach involves the handling of multiple sediments. Typically, the presence of each sediment type introduces an additional wave in the transport system. As a result, solving such a transport system with complete eigendecomposition of the Jacobian matrix, as with Roe solvers may become very expensive as the number of sediment or grain sizes increase. See, e.g., Murillo et al., “An Exner-based coupled model for two-dimensional transient flow over erodible bed”, Journal of Computational Physics, Vol. 229, pp. 8704-8732 (2010). As a result, a Roe type solver may be unsuitable for problems with a large number of sediments. For non-linear solvers, such as HLL, the individual sediment waves are not considered and produce overly diffusive schemes, as noted above. Moreover, water-at-rest condition or the no-sediment transport condition for individual sediment size or grain size is not satisfied.

As the grain size distribution is useful in determining the properties of a hydrocarbon reservoir, it may be particularly desirable to model cases where the shear stress is above the critical value only for sediments below a certain size, and hence only these smaller sediment sizes are in motion, while the larger ones are not being transported by flow via bedload transport. See, e.g., Parker et al., “Effect of floodwater extraction on mountain stream morphology”, Journal of Hydraulic Engineering, Vol. 129, pp. 885-895 (2003). However, as described above conventional approaches are unsuitable to perform this modeling.

Accordingly, there remains a need in the industry for methods and systems that are more efficient and may lessen problems associated with characterizing the subsurface properties in a subsurface model for use in hydrocarbon operations. Further, a need remains for efficient approaches to model and/or simulate sedimentary deposits in the subsurface region that were formed by turbidity current(s). The present techniques provide methods and systems that overcome one or more of the deficiencies discussed above.

### SUMMARY

In one embodiment, a method for enhancing hydrocarbon operations for a subsurface region is described. The method may comprise: obtaining a subsurface model of a subsurface region, wherein the subsurface model comprises a plurality of cells and respective cell interfaces are formed between the plurality of cells and comprises a plurality of surfaces; identifying one or more surfaces from the plurality of surfaces within the subsurface model; obtaining paleo-flow data associated with the identified one or more surfaces; determining a simulation model to represent the identified one or more surfaces; determining two or more grain sizes to be modeled in the simulation model; determining a plurality of time steps for a simulation of the paleo-flow that formed the one or more surfaces; simulating paleo-flow with the simulation model to predict the distribution of the two or more grain sizes in the one or more surfaces to predict a grain size distribution in the one or more surfaces; and outputting the grain size distribution in the one or more surfaces from the simulation.

In other embodiments, the method may include various enhancements. The method may include wherein the paleo-flow data comprises bathymetry data; wherein the paleo-flow data comprises flow conditions at an inlet associated with the identified one or more surfaces; wherein the simulating paleo-flow within the subsurface model further comprises: calculating bedload flux at each of the respective cell interfaces for each of the two or more grain sizes; wherein the simulating paleo-flow with the simulation model further comprises: determining one or more initial conditions for each of the respective cell interfaces, and calculating fluxes at each of the respective cell interfaces; wherein the simulating paleo-flow with the simulation model further comprises: computing one or more wave speeds for each of the two or more grain sizes, and calculating bedload fluxes for each of the respective cell interfaces for each of the two or more grain sizes; wherein the simulating paleo-flow with the simulation model further comprises: calculating hydrodynamic flux for each of the two or more grain sizes for one or more hydrodynamic variables; wherein the simulating the paleo-flow with the simulation model further comprises: computing hydrodynamic wave speeds for each of the two or more grain sizes for one or more hydrodynamic variables with the average properties in a bed in the simulation model; wherein the simulating the paleo-flow with the simulation model further comprises: computing hydrodynamic flux for each of the two or more grain sizes for one or more hydrodynamic variables at the respective cell interfaces; further comprising simulating fluid flow within the subsurface model based on the outputted grain size distributions in the one or more surfaces; further comprising causing a well to be drilled based on the one of the outputted grain size distributions in the one or more surfaces, the output results, the simulated fluid flow, and any combination thereof; and/or comprising performing a hydrocarbon operation based on the one of the outputted grain size distributions in the one or more surfaces, the output results, the simulated fluid flow, and any combination thereof.

In another embodiment, a system for generating a subsurface model associated with a subsurface region is described. The system comprises: a processor; an input device in communication with the processor and configured to receive input data associated with a subsurface region; memory in communication with the processor, the memory having a set of instructions. The set of instructions, when executed by the processor, are configured to: obtain a subsurface model of a subsurface region, wherein the subsurface model comprises a plurality of cells and respective cell interfaces are formed between the plurality of cells and comprises a plurality of surfaces; identify one or more surfaces from the plurality of surfaces within the subsurface model; obtain paleo-flow data associated with the identified one or more surfaces; determine a simulation model to represent the identified one or more surfaces; determine two or more grain sizes to be modeled in the simulation model; determine a plurality of time steps for a simulation of the paleo-flow that formed the one or more surfaces; simulate paleo-flow with the simulation model to predict the distribution of the two or more grain sizes in the one or more surfaces to predict a grain size distribution in the one or more surfaces; and output the grain size distribution in the one or more surfaces from the simulation.

In other embodiments, the system may include various enhancements. The system may include wherein the set of instructions, when executed by the processor, are configured to: calculate bedload flux at each of the respective cell interfaces for each of the two or more grain sizes; wherein the set of instructions, when executed by the processor, are configured to: determine one or more initial conditions for each of the respective cell interfaces, and calculate fluxes at each of the respective cell interfaces; wherein the set of instructions, when executed by the processor, are configured to: compute one or more wave speeds for each of the two or more grain sizes, and calculate bedload fluxes for each of the respective cell interfaces for each of the two or more grain sizes; wherein the set of instructions, when executed by the processor, are configured to calculate hydrodynamic flux for each of the two or more grain sizes for one or more hydrodynamic variables; wherein the set of instructions, when executed by the processor, are configured to compute hydrodynamic wave speeds for each of the two or more grain sizes for one or more hydrodynamic variables with the average properties in a bed in the simulation model; wherein the set of instructions, when executed by the processor, are configured to: compute hydrodynamic flux for each of the two or more grain sizes for one or more hydrodynamic variables at the respective cell interfaces; and/or wherein the set of instructions, when executed by the processor, are configured to display a notification for a location to drill a well based on the outputted grain size distribution.

### BRIEF DESCRIPTION OF THE DRAWINGS

The advantages of the present invention are better understood by referring to the following detailed description and the attached drawings.

FIG. 1 is an exemplary diagram of a finite volume discretization of a computing cell using a Cartesian grid.

FIG. 2 is an exemplary diagram of a Riemann solver configuration.

FIG. 3 is an exemplary flow chart in accordance with one or more embodiments of the present techniques.

FIG. 4 is another exemplary flow chart in accordance with one or more embodiments of the present techniques.

FIG. 5 is a block diagram of a computer system that may be used to perform any of the methods disclosed herein.

### DETAILED DESCRIPTION

In the following detailed description section, the specific embodiments of the present disclosure are described in connection with preferred embodiments. However, to the extent that the following description is specific to a particular embodiment or a particular use of the present disclosure, this is intended to be for exemplary purposes only and simply provides a description of the exemplary embodiments. Accordingly, the disclosure is not limited to the specific embodiments described below, but rather, it includes all alternatives, modifications, and equivalents falling within the true spirit and scope of the appended claims.

Various terms as used herein are defined below. To the extent a term used in a claim is not defined below, it should be given the broadest definition persons in the pertinent art have given that term as reflected in at least one printed publication or issued patent.

The articles “the”, “a”, and “an” are not necessarily limited to mean only one, but rather are inclusive and open ended so as to include, optionally, multiple such elements.

As used herein, the term “hydrocarbons” are generally defined as molecules formed primarily of carbon and hydrogen atoms such as oil and natural gas. Hydrocarbons may also include other elements or compounds, such as, but not limited to, halogens, metallic elements, nitrogen, oxygen, sulfur, hydrogen sulfide (H₂S), and carbon dioxide (CO₂). Hydrocarbons may be produced from hydrocarbon reservoirs through wells penetrating a hydrocarbon containing formation. Hydrocarbons derived from a hydrocarbon reservoir may include, but are not limited to, petroleum, kerogen, bitumen, pyrobitumen, asphaltenes, tars, oils, natural gas, or combinations thereof. Hydrocarbons may be located within or adjacent to mineral matrices within the earth, termed reservoirs. Matrices may include, but are not limited to, sedimentary rock, sands, silicilytes, carbonates, diatomites, and other porous media.

As used herein, “hydrocarbon exploration” refers to any activity associated with determining the location of hydrocarbons in subsurface regions. Hydrocarbon exploration normally refers to any activity conducted to obtain measurements through acquisition of measured data associated with the subsurface formation and the associated modeling of the data to identify potential locations of hydrocarbon accumulations. Accordingly, hydrocarbon exploration includes acquiring measurement data, modeling of the measurement data to form subsurface models, and determining the likely locations for hydrocarbon reservoirs within the subsurface. The measurement data may include seismic data, gravity data, magnetic data, electromagnetic data, and the like.

As used herein, “hydrocarbon development” refers to any activity associated with planning of extraction and/or access to hydrocarbons in subsurface regions. Hydrocarbon development normally refers to any activity conducted to plan for access to and/or for production of hydrocarbons from the subsurface formation and the associated modeling of the data to identify preferred development approaches and methods. By way of example, hydrocarbon development may include modeling of the subsurface formation and extraction planning for periods of production, determining and planning equipment to be utilized and techniques to be utilized in extracting the hydrocarbons from the subsurface formation, and the like.

As used herein, “hydrocarbon operations” refers to any activity associated with hydrocarbon exploration, hydrocarbon development and/or hydrocarbon production.

As used herein, “hydrocarbon production” refers to any activity associated with extracting hydrocarbons from subsurface location, such as a well or other opening. Hydrocarbon production normally refers to any activity conducted to form the wellbore along with any activity in or on the well after the well is completed. Accordingly, hydrocarbon production or extraction includes not only primary hydrocarbon extraction, but also secondary and tertiary production techniques, such as injection of gas or liquid for increasing drive pressure, mobilizing the hydrocarbon or treating by, for example, chemicals, hydraulic fracturing the wellbore to promote increased flow, well servicing, well logging, and other well and wellbore treatments.

As used herein, “subsurface model” refers to a model of a subsurface region and may include a reservoir model, geomechanical model, and/or a geologic model. The subsurface model may include subsurface data distributed within the model in two-dimensions (2-D) (e.g., distributed into a plurality of cells, such as mesh elements or blocks), three-dimensions (3-D) (e.g., distributed into a plurality of voxels), or more dimensions.

As used herein, a “geologic model” is a subsurface model (e.g., a 2-D model or a 3-D model) of the subsurface region having static properties and includes objects, such as faults and/or horizons, and properties, such as facies, lithology, porosity, permeability, or the proportion of sand and shale.

As used herein, a “reservoir model” is a subsurface model (e.g., a 2-D model or a 3-D model) of the subsurface that in addition to static properties, such as porosity and permeability, also has dynamic properties that vary over the timescale of resource extraction, such as fluid composition, pressure, and relative permeability.

As used herein, a “geomechanical model” is a model (e.g., a 2-D model or a 3-D model) of the subsurface that contain properties, such as static properties and may model responses to changes in stress, such as mechanical response. The static properties may include properties, such as rock compressibility and Poisson's ratio, while the mechanical response may include compaction, subsidence, surface heaving, faulting, and seismic events, which may be a response to fluid injection and extraction from the subsurface region.

As used herein, “simulation model” refers to a model of a volume or region that is used in a simulation. The simulation model may model a surface region, subsurface region and material flow over a surface (e.g., different sediments or grain sizes along with fluid flow). The simulation model may include material data and flow data distributed within the model in two-dimensions (2-D) (e.g., distributed into a plurality of cells, such as mesh elements or blocks), three-dimensions (3-D) (e.g., distributed into a plurality of voxels), or more dimensions.

As used herein, “paleo-flow” refers to material flow, which may include different sediments or grain sizes along with fluid flow. Paleo-flow may represent historical material flow, which may have occurred many years prior to the present time.

As used herein, “structural framework” or “framework” refer to a subsurface representation formed from objects (e.g., faults, horizons, other surfaces and model boundaries). For example, the framework is a subsurface representation that contains surfaces and polylines. A framework may be formed by surfaces of geologic, engineering, planning, or other technical relevance.

As used herein, “zone”, “region”, “container”, or “compartment” is a defined space, area, or volume contained in the framework or model, which may be bounded by one or more objects or a polygon encompassing an area or volume of interest. The volume may include similar properties.

As used herein, “mesh” or “grid” is a representation of a region of space (e.g., 2-D domain or 3-D domain), which includes nodes that may form mesh elements, such as polygons or polyhedra, disposed within the region (e.g., a volumetric representation). The mesh may represent surfaces, horizons, faults, and/or other objects by a set of nodes, which may include various mesh elements in the form of polygons or polyhedra, disposed within the region. Properties may be assigned to or associated with the mesh elements.

As used herein, “simulate” or “simulation” is the process of performing one or more operations using a subsurface model and any associated properties to create simulation results. For example, a simulation may involve computing a prediction related to the resource extraction based on a reservoir model. A reservoir simulation may involve performing by execution of a reservoir-simulator computer program on a processor, which computes composition, pressure, and/or movement of fluid as a function of time and space for a specified scenario of injection and production wells by solving a set of reservoir fluid flow equations. A geomechanical simulation may involve performing by execution of a geomechanical simulator computer program on a processor, which computes displacement, strain, stress, shear slip, and/or energy release of the rock as a function of time and space in response to fluid extraction and injection.

In hydrocarbon operations, a subsurface model is created in the physical space or domain to represent the subsurface region. The subsurface model is a computerized representation of a subsurface region based on geophysical and geological observations made on and below the surface of the Earth. The subsurface model may be a numerical equivalent of a reservoir map (e.g., 2-D reservoir map or 3-D reservoir map) complemented by a description of physical quantities in the domain of interest. The subsurface model may include multiple dimensions and is delineated by objects, such as horizons, fractures, and faults. The subsurface model may include a structural framework of objects, such as faults, fractures, and horizons. Within the subsurface models, a grid or mesh may be used to partition the model into different subvolumes, which may be used in hydrocarbon operations, such as reservoir simulation studies in hydrocarbon exploration, development, and/or production operations, as well as for representing a subsurface model description of a reservoir structure and material properties. The subsurface model may include a mesh or grid of nodes to divide the structural framework and/or subsurface model into mesh elements, which may include cells or blocks in 2-D, or voxels in 3-D, or other suitable mesh elements in other dimensions. Accordingly, the mesh may be configured to form mesh elements that may represent material properties, such as rock and fluid properties, of a reservoir or may be used for numerical discretization of partial differential equations, such as fluid flow or wave propagation.

To enhance the understanding of the subsurface regions represented by the subsurface model, reservoir simulations may be performed. For example, the reservoir simulations may relied upon to determine well locations, well orientations, specific regions that may be used to economically produce hydrocarbons from a subsurface region. Further, the reservoir simulations may be used to enhance hydrocarbon operations associated with that subsurface region, which may include asset acquisition evaluation, selection of drill site and completion zones and/or equipment, and/or stimulation or injection planning.

As described above, sedimentary depositional processes can leave subsurface features that are evident even in reservoirs that have undergone millions of years of diagenesis, and can be important in controlling flow in the reservoir. For example, hydrocarbon reservoirs may be formed as a result of sedimentary deposits from currents, such as subaqueous turbidity currents. Such currents can be responsible for moving sediment (usually sourced from onshore rivers) from the continental shelf through submarine canyons in the continental slope to submarine fans on the abyssal plain of the sea floor. In general, turbidity currents are special cases of gravity flows, in which the sediment which gives the current its excess density (which drives downslope current movement under gravity) is itself suspended by the turbulence generated of the motion. Depth-averaged models of turbidity current flow, erosion, and deposition can be used to numerically simulate the flow of the turbidity current.

The present techniques involve enhancements to determine the grain size distribution in one or more surfaces in a subsurface region. In particular, the present techniques simulate the formation of sedimentary deposits by a turbidity current. The present techniques employ a depth averaged model and solves for the spatial and temporal evolution of current thickness, velocity, sediment concentration (for each sediment size or grain size), turbulent kinetic energy, deposit thickness (for each sediment size or grain size), and the overall bed elevation. The sediment transported by the current includes the part that occurs in suspension as well as the part that occurs as bedload flux. The bedload flux is incorporated in the present techniques by using an enhanced coupled algorithm, which maintains numerical stability even in supercritical flows. In contrast to conventional approaches, as noted above, the present techniques satisfy the water-at-rest condition, no-sediment transport condition (if applicable), and may handle multiple sediments efficiently. This resulting information is used to enhance subsequent reservoir simulations of fluid flow and associated hydrocarbon operations.

As noted above, turbidity current refers to deepwater underflows driven by the density difference between the suspended particles in the current and the ambient fluid. The sediment transported by the turbidity current occurs in a variety of regimes depending on the Rouse number, which expresses the ratio of gravitational settling and turbulent mixing. For sediments with small Rouse numbers (Ro) (e.g., Ro less than (<) 0.5), a significant portion of the transport occurs in suspension as the turbulence mixing dominates the particle settling. However, for sediments with larger Rouse numbers (e.g., Ro>0.5), where the turbulence mixing is not strong relative to particle settling, the transport may be dominated by bedload transport.

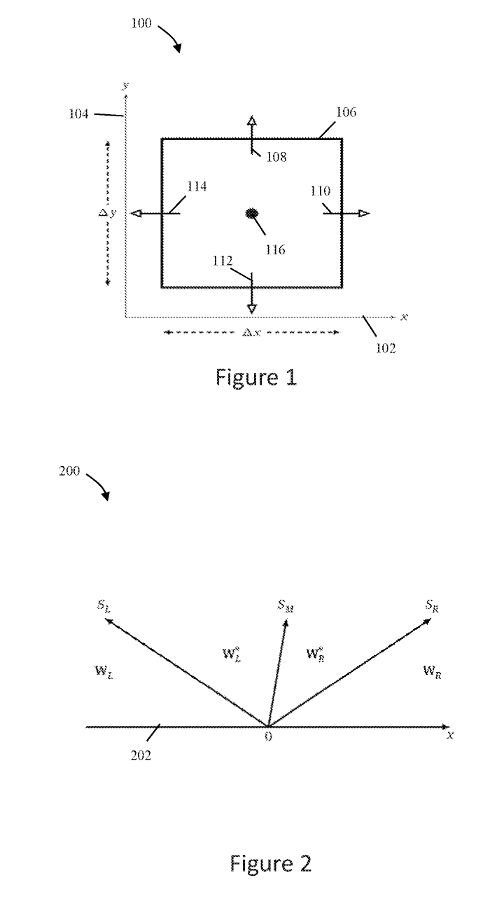

In the present techniques, the determination of bedload flux of particles noted above is to be performed in conjunction with the flux of other flow variables (e.g., they be fully coupled). Further, the present techniques address the deficiencies of satisfying the water-at-rest condition; satisfying the no-sediment transport condition when the shear stress is below the critical shear stress for that sediment size or grain size; lessening the computational expense for large scale problems (e.g., due to the lack of the need for computing the eigenvectors and eigenvalues of the augmented Jacobian matrix); minimizing diffusion; and properly handling multiple sediments or grain sizes in an efficient manner as the number of sediment sizes or grain sizes increase. The present techniques may be further understood with reference to FIGS. 1 to 5, which are described further below.

The present techniques provide a non-linear solver based on the Harten-Lax-van Leer (HLL) method. However, unlike other methods based on the HLL method, the present techniques involve an additional wave in the solver, which may be referred to as a three-wave (3-wave) solver. By utilizing the relationship between the two intermediate states in a 3-wave solver, the present techniques may satisfy the water-at-rest property, no-sediment transport property (when shear stress is less than the critical value for the given grain size), while also minimizing the numerical diffusion. To handle multiple sediments, the present techniques utilize an efficient technique that involves solving a series of sub-problems involving a single sediment size or a single grain size. As a result, the computational cost of the calculating wave speeds increase linearly with the number of sediments, which is a preferred property. Accordingly, the present techniques satisfy the no-sediment transport property (when applicable) for each sediment size or grain size and may also provide a less diffusive scheme than conventional approaches.

The depth averaged turbidity current model utilizes the following set of equations (e1) to (e6) below:

$$\begin{matrix} \frac{\partial h}{\partial t} + \frac{\partial hu}{\partial x} + \frac{\partial hv}{\partial y} = {E}_{w} \sqrt{{u}^{2} + {v}^{2}} , & ( e1 ) \\ \frac{\partial hu}{\partial t} + \frac{\partial {hu}^{2}}{\partial x} + \frac{\partial huv}{\partial y} + \frac{1}{2} gR \frac{\partial {h}^{2} c}{\partial x} = - \frac{gRhc \partial ( z + η )}{\partial x} - {c}_{D} u \sqrt{{u}^{2} + {v}^{2}} , & ( e2 ) \\ \frac{\partial hv}{\partial t} + \frac{\partial huv}{\partial x} + \frac{\partial {hv}^{2}}{\partial y} + \frac{1}{2} gR \frac{\partial {h}^{2} c}{\partial x} = - \frac{gRhc \partial ( z + η )}{\partial y} - {c}_{D} v \sqrt{{u}^{2} + {v}^{2}} , & ( e3 ) \\ \frac{\partial {hc}_{i}}{\partial t} + \frac{\partial {huc}_{i}}{\partial x} + \frac{\partial {hvc}_{i}}{\partial y} = {E}_{i} - {D}_{i} & ( e4 ) \\ \frac{\partial hk}{\partial t} + \frac{\partial huk}{\partial x} + \frac{\partial hvk}{\partial y} = P - ϵ - gRh {Σ}_{i} {c}_{i} {w}_{s , i} , & ( e5 ) \\ ( 1 - ϕ ) \frac{\partial {η}_{i}}{\partial t} + \frac{\partial {q}_{i}^{x}}{\partial x} + \frac{\partial {q}_{i}^{y}}{\partial y} = {E}_{i} - {D}_{i} , & ( e6 )\end{matrix}$$

where h is current thickness; u and v are flow velocity components in x and y directions, respectively; cᵢ is volumetric concentration of i^{th} sediment type; k is turbulent kinetic energy; n is number of sediment types; c is total sediment concentration; g is a gravity constant (e.g., g is 9.81 meter per squared second (m/s²)); R is relative sediment density (e.g., for quartz R is approximately 1.65); ηᵢ is deposited sediment thickness of i^{th} sediment type; η is total deposited sediment thickness; z is the total bed elevation; E_{w} is clear water entrainment rate; C_{D} is bed drag coefficient; Eᵢ is erosion rate of i^{th} sediment; Dᵢ is deposition rate of i^{th} sediment; φ sediment layer porosity; qᵢ^{x} and qᵢ^{y} are bedload fluxes in x, y directions of i^{th}sediment; P−ϵ is production and total expenditure of turbulent kinetic energy, respectively; and wₛᵢ is settling velocity of the i^{th} sediment.

In the present techniques, to track the vertical distribution of the deposited grain sizes, the deposits at each location may be subdivided into layers in the vertical direction. In such a case, equation (e6) is written only for the top-most layer, where the sediment transport actually occurs. The aforementioned sediment management scheme into layers follows closely the procedure outlined by Belleudy et al., “Numerical simulation of sediment mixture deposition part 1: analysis of a flume experiment”, Journal of Hydraulic Research, Vol. 38, pp. 417-425 (2000). Note that this sediment management scheme does not change the deposit thickness or the grain size distribution at any given point; instead it just provides a convenient data structure for storing the results related to the deposits produced of the simulation.

In other configurations, the set of equations (e1) to (e6) may be expressed as the following vector form in equation (e7):

$$\frac{\partial U}{\partial t} + \frac{\partial F}{\partial x} + \frac{\partial G}{\partial y} = Q , \qquad ( e7 )$$

where U=(h,hu.hv,hk,hcᵢ,ηᵢ) is the vector of depth-averaged variables, F=(Fₕ, Fₕᵤ, Fₕᵥ, Fₕₖ, F_{hci}, F_{ηi}) and G=(Gₕ, Gₕᵤ, Gₕᵥ, Gₕₖ, G_{hci}, G_{ηi}) are vectors of corresponding fluxes in x and y directions, respectively, and Q=(Qₕ, Qₕᵤ, Qₕᵥ, Qₕₖ, Q_{hci}, Q_{ηi}) is the vector of source terms.

As previously noted, bedload transport is a mode of sediment transport where sediment particles primarily roll, slide, or saltate along the bed. In the conventional expressions for the bedload transport rate, the sediment movement may be controlled by a critical shear stress, above which the movement is initiated. Moreover, bedload flux expressions only depend on the hydrodynamic variables and does not take into account the sediment layer thickness. Ultimately, expressions may be written in the following equations (e8) and (e9):

$$\begin{matrix}{q}_{x} = \sqrt{{gRD}^{3}} Φ ( {τ}^{*} , {τ}_{c}^{*} ) , and & ( e8 ) \\ {τ}^{*} = \frac{{c}_{D} u \sqrt{{u}^{2} + {v}^{2}}}{gRD} , & ( e9 )\end{matrix}$$

where D is the diameter of the sediment. When y component of bedload flux is computed, then u should be replaced with v in the calculation of τ*. All differences between different bedload models are reflected in the form of function Φ (τ*,τ_{c}*). By way of example, equations (e10) to (e11), are examples of expressions for the function Φ (τ*, τ_{c}*):

Φ=17(τ*−τ_{c}*)(\sqrt{τ*}−\sqrt{τ_{c}*}) (e10); and

Φ=8(τ*−τ_{c}*)^{3/2} (e11).

Equation (e10) is an example of the function described in Ashida et al., “Study on Hydraulic Resistance and Bedload Transport Rate in Alluvial Streams”, Transactions of Japan Society of Civil Engineers, Vol. 206, pp. 59-69 (1972). Equation (e11) is an example of the function described in Meyer-Peter et al., “Formulas for Bed-Load Transport”, Proceedings, 2^{nd} Congress, International Association for Hydraulic Structures Research, Appendix 2, pp. 39-64 (1948). The non-dimensional critical shear stress typically takes a value of around τ_{c}* approximately equal to 0.05. For example, in the model based on equation (e11), the critical shear stress is taken as τ_{c}* equal to 0.047. In other approaches, a grain size dependent critical shear stress may be used. See e.g., William R. Brownlie, “Compilation of Alluvial Channel Data: Laboratory and Field”, Report No. KH-R-43B, California Institute of Technology, pp. 1-216 (1981) and Parker et al., “Effect of Floodwater Extraction on Mountain Stream Morphology”, Journal of Hydraulic Engineering, Vol. 129, p. 885-895 (2003). When a mixture of sediments is utilized, the expression for bedload flux can be modified as follows in equation (e12):

qᵢ^{x}=pᵢ\sqrt{gRDᵢ³}Φ(τᵢ*−τ_{ci}*) (e12);

where pᵢ is the fraction of sediment i in the active layer (top most part of the erodible sediment bed which moves due to the action of shear stress).

To numerically solve the system of equations (e1) to (e6), a finite volume spatial discretization and a semi-implicit temporal discretization, which are both first order accurate, may be used. FIG. 1 is an exemplary diagram 100 of a finite volume discretization of a computing cell using a Cartesian grid. This diagram 100 of a computing cell 106 shown along the x differential (Λx) axis 102 and the y differential axis (Λy) 104. The computing cell 106 has four edges that each have a corresponding flux, such as fluxes 108, 110, 112 and 114, and a center point 116.

The computing cell 106 may be used to numerically solve the system of equations (e1) to (e6). For the spatial aspect, the domain is divided into a collection of structured rectangular cells I_{i,j} with center point at x_{i,j}. Without loss of generality, the x and y dimensions of the cell are assumed to be equal, which are shown along the axis 102 and 104, respectfully. Accordingly, the center point 116 may be U_{i,j}ⁿ the flux 108 may be

$${G}_{i , j + \frac{1}{2}}^{n} ,$$

the flux 110 may be

$${F}_{i + \frac{1}{2} , j}^{n} ,$$

the flux 112 may be

$${G}_{i , j - \frac{1}{2}}^{n}$$

and the flux 114 may be

$${F}_{i - \frac{1}{2} , j}^{n} .$$

For the temporal discretization, all terms except the drag related source terms are treated explicitly. The time step may be represented by Δt. The cell averaged quantities in cell (i,j) are then evolved as per the following equation (e13):

$${U}_{i , j}^{n + 1} = {U}_{i , j}^{n} - \frac{Δ t}{Δ x} ( {F}_{i + \frac{1}{2} , j}^{n} - {F}_{i - \frac{1}{2} , j}^{n} ) - \frac{Δ t}{Δ y} ( {G}_{i , j + \frac{1}{2}}^{n} - {G}_{i , j - \frac{1}{2}}^{n} ) + Δ {tQ}_{{1}_{i , j}}^{n} + Δ {tQ}_{{2}_{i , j}}^{n + 1} . \qquad ( e13 )$$

In the above equation (e13), Q₁ is the source term excluding the drag related term, which is contained in the term Q₂. The two non-zero components of Q₂ are discretized implicitly in a linearized manner as follows in equations (e14) and (e15):

$$\begin{matrix}{Q}_{2 , hu}^{n + 1} = - {c}_{D} \frac{{hu}^{n + 1}}{{h}^{n}} \sqrt{{u}^{2 , n} + {v}^{2 , n}} ; and & ( e14 ) \\ {Q}_{2 , hv}^{n + 1} = - {c}_{D} \frac{{hv}^{n + 1}}{{h}^{n}} \sqrt{{u}^{2 , n} + {v}^{2 , n}} . & ( e15 )\end{matrix}$$

Given the linearized discretization of the implicit term, the equation (e13) is easily solved to produce U_{i,j}ⁿ⁺¹ for each cell (i,j), such as center point 116.

The above method has a reduced stability region with respect to allowable time step values, as shown in equation (e16) as follows:

$$Δ t \leq \frac{Δ x}{{\sqrt{2} max}_{i , j} ( {s}_{x} , {s}_{y} )} , \qquad ( e16 )$$

where sₓ and s_{y} are wave speeds in the hyperbolic part of the problem propagating within a given cell (i,j) in x and y directions, respectively. In various configurations, the following criterion may be used, as shown in equation (e17):

$$Δ t \leq \frac{Δ x}{2 {max}_{i , j} ( s )} , \qquad ( e17 )$$

where the maximum speed is taken among all waves within all cells. This selection provides that the waves propagating from the interface of two cells does not interfere with any other waves propagating from any other interface in the respective time step.

The Riemann solver for one-dimensional (1D) flux may be used to calculate the fluxes for the cells, such computing cell 106 of FIG. 1. The numerical fluxes

$${F}_{i + \frac{1}{2} , j}^{n}$$

and

$${G}_{i , j + \frac{1}{2}}^{n}$$

may be calculated separately in a 1D fashion. For each of these calculations, a velocity normal to the interface and a velocity tangential to the interface is specified. For example, in the calculation of the flux

$${F}_{i + \frac{1}{2} , j}^{n} ,$$

u is the normal velocity and v is the tangential velocity. Once this is specified, the calculations proceed in similar manners. For exemplary purposes, this example is described in relation to a 1D problem with two cells with the state in left cell denoted by W_{L} and the state in the right cell denoted by W_{R} as shown in FIG. 2.

FIG. 2 is an exemplary diagram 200 of a Riemann solver configuration. In this diagram 200, the wave speeds s_{L}, s_{M}, and s_{R} is shown along the x axis 202. The wave speeds s_{L}, s_{M}, and s_{R} divide the diagram 200 into four states W_{L}, W_{L}*, W_{R}* and W_{R}. The states W_{L} and W_{R} are known states at the left and right cell at the interface of which the flux is to be computed. The W_{L}* and W_{R}* are the intermediate states and are computed as part of the solution procedure described below. The wave speeds s_{L}, s_{M} and s_{R} are also computed as part of the solution procedure described below.

In the present techniques, the Riemann solver employed is an approximate solver and assumes that the Riemann solution involves a series of shocks moving at constant speeds, such that a jump condition holds across every shock. In addition, a consistency condition is defined that denotes balance over the entire wave structure as follows in equation (e18):

F_{L}−F_{R}+B=s_{L}(W_{L}−W_{L}*)+s_{M}(W_{L}*−W_{R}*)+s_{R}(W_{R}*−W_{R}) (e18)

where F_{L} and F_{R} are the fluxes based on the left and the right state, and B is a consistent approximation of the slope source term only (rest of the vector entries are zero). Explicit inclusion of a source term in the Riemann solver provides a mechanism to construct a well-balanced scheme. The conditions above may not be enough to uniquely define a Riemann solution and some additional relationships for intermediate states have to be introduced as noted below. When all intermediate states have been determined, the flux at the interface between two cells can be obtained by using the equation (e19):

F*=1/2(F_{L}+F_{R})−|s_{L}|(W_{L}*−W_{L})−|s_{M}|(W_{R}*−W_{L}*)−|s_{R}|(W_{R}−W_{R}*) (e19)

This equation (e19) is used to compute fluxes for h, hu, and η component only. The flux for a passive component, like the sediment concentration, may be computed in a standard HLLC approach as shown in equation (e20):

F_{hci}=Fₕc_{upw} (e20);

where c_{upw} is an upwinded value of sediment concentration based on the sign of flux F^{h}, i.e., if F^{h} is positive then c_{upw}=c_{L} otherwise c_{upw}=c_{R}.

When equation (e18) is applied to this problem, the result is the equations (e21) to (e23), which relates to FIG. 2:

h_{R}u_{R}−h_{L}u_{L}=s_{L}(h_{L}*−h_{L})+s_{M}(h_{R}*−h_{L}*)+s_{R}(h_{R}−h_{R}) (e21);

(h_{R}u_{R}²+1/2gRc_Rh_{R}²)−(h_{L}u_{L}²+1/2gRc_{L}h_{L}²)−B=s_{L}(h_{L}*u_{L}*−h_{L}u_{L})+s_M(h_{R}*u_{R}*−h_{L}*u_{L}*)+s_R(h_{R}u_{R}−h_{R}*u_{R}*) (e22); and

q_{R}−q_{L}=s_{L}(z_{L}*−z_{L})+s_{M}(z_{R}*−z_{L}*)+s_{R}(z_{R}−z_{R}*) (e23).

In the equations (e21) to (e23), a three wave Riemann solver is assumed to account for a varying bed elevation that evolves through bedload, as shown in FIG. 2. As a result, six unknowns are present in the three equations (e21) to (e23). Thus, additional relationships have to be utilized, which we choose to be the following equations (e24), (e25), and (e26):

$$\begin{matrix}{h}_{R}^{*} {u}_{R}^{*} - {h}_{L}^{*} {u}_{L}^{*} = {s}_{M} ( {h}_{R}^{*} - {h}_{L}^{*} ) ; & ( e24 ) \\ \frac{{h}_{L}^{*} - {h}_{R}^{*}}{{z}_{L}^{*} - {z}_{R}^{*}} = α ; and & ( e25 ) \\ {z}_{R}^{*} = {z}_{R} . & ( e26 )\end{matrix}$$

The equation (e24) is a jump condition across the middle wave only for the fluid mass balance, and is utilized due to its linear nature. The second equation (e25) is based on the Riemann-invariant condition across the middle wave. The Riemann invariant condition applies across weak shocks or rarefaction waves and may be computed in general for two-variable systems. For example, see Randall J. LeVeque, “Finite-Volume Methods for Hyperbolic Problems”, Cambridge University Press, pp. 1-553 (2002). Nonetheless, it is useful in our calculations on a general problem as well. The value of α is computed by converting the multi-variable problem to a quasi 2-variable system in h and z and by using an average value for u and hc.

Following the above prescription, the resulting value of α is set forth in equation (e27):

$$α = \frac{{( \overline{u} - {s}_{M} )}^{2}}{gR \overline{hc}} - 1 ; \qquad ( e27 )$$

where

$$\overline{u} = \frac{{u}_{L} + {u}_{R}}{2} and \overline{hc} = \frac{{h}_{L} {c}_{L} + {h}_{R} {c}_{R}}{2} .$$

The value of a in the equation (e27) provides that the water-at-rest condition is satisfied in the corresponding case. Note that α=−1 when there is no flow, essentially leading to the following condition between the states across the middle wave as set forth in equation (e28):

h_{L}*+z_{L}*=h_{R}*+z_{R}* (e28).

Alternatively, the above equations may also be specified as the relationship between the intermediate states for all conditions instead of equation (e27). This satisfies the water-at-rest condition, however, its accuracy may decrease as the flow speed increases. Finally, the last condition in equation (e26) implies that the right most region is mostly hydrodynamic in nature and is not affected by bedload transport and the value of z does not change across the fastest wave speed s_{R.}

The solution of equations (e21) to (e26) is provided in equations (e29) to (e36):

$$\begin{matrix} {z}_{L}^{*} = \frac{{s}_{M} {z}_{R} - {s}_{L} {z}_{L} + {q}_{L} - {q}_{R}}{{s}_{M} - {s}_{R}} , {z}_{R}^{*} = {z}_{R} , & ( e29 ) \\ {h}_{L}^{*} = {h}_{HLL} + \frac{( {s}_{R} - {s}_{M} ) ( {z}_{R}^{*} - {z}_{L}^{*} )}{{s}_{R} - {s}_{L}} , & ( e30 ) \\ {h}_{R}^{*} = {h}_{HLL} + \frac{( {s}_{L} - {s}_{M} ) ( {z}_{R}^{*} - {z}_{L}^{*} )}{{s}_{R} - {s}_{L}} , & ( e31 ) \\ {h}_{L}^{*} {u}_{L}^{*} = {hu}_{HLL} - \frac{B}{{s}_{R} - {s}_{L}} + \frac{{s}_{M} ( {s}_{R} - {s}_{M} )}{{s}_{R} - {s}_{L}} ( {z}_{R}^{*} - {z}_{L}^{*} ) , & ( e32 ) \\ {h}_{R}^{*} {u}_{R}^{*} = {hu}_{HLL} - \frac{B}{{s}_{R} - {s}_{L}} - \frac{{s}_{M} ( {s}_{M} - {s}_{L} )}{{s}_{R} - {s}_{L}} ( {z}_{R}^{*} - {z}_{L}^{*} ) , where & ( e33 ) \\ {h}_{HLL} = \frac{{s}_{R} {h}_{R} - {s}_{L} {h}_{L} - {h}_{R} {u}_{R} - {h}_{L} {u}_{L}}{{s}_{R} - {s}_{L}} and & ( e34 ) \\ {hu}_{HLL} = \frac{{s}_{R} {h}_{R} {u}_{R} - {s}_{L} {h}_{L} {u}_{L} ( {h}_{R} {u}_{R}^{2} + \frac{1}{2} {gRc}_{R} {h}_{R}^{2} ) + ( {h}_{L} {u}_{L}^{2} + \frac{1}{2} {gRc}_{L} {h}_{L}^{2} )}{{s}_{R} - {s}_{L}} . & ( e35 )\end{matrix}$$

Equations (e34) and (e35) are intermediate states from a standard HLL solver. With the knowledge of the intermediate states, the method may compute the fluxes from equation (e19). In particular, the bedload flux at the interface F_{b}* is computed first. This is followed by the computation of the flux for the current thickness (Fₕ*) and for the normal momentum (Fₕᵤ*). Lastly, the flux for all the passively transported quantities are computed: Fₕᵥ*, F_{hc}* and F_{hc}*.

The wave speeds s_{L}, s_{M}, and s_{R} may be calculated using the following equations (e36), (e37), and (e38):

s_{L}=min(λ_{1,L}, λ_{1,R}), (e36),

s_{M}=max(λ_{2,L}, λ_{2,R}) (e37), and

s_{R}=max(λ_{3,L}, λ_{3,R}) (e38).

where λ₁, λ₂, λ₃ are the eigenvalues of a flux Jacobian matrix A that also includes a slope term contribution as shown in equation (e39):

$$A = \begin{matrix}0 & 1 & 0 & 0 \\ - {u}^{2} + \frac{1}{2} gRch & 2 u & \frac{1}{2} gRh & gRch \\ - uc & c & u & 0 \\ β & γ & 0 & 0\end{matrix} , \qquad ( e39 )$$

where

$$β = \frac{\partial {q}^{b}}{\partial h} , γ = \frac{\partial {q}^{b}}{\partial hu} .$$

The characteristic polynomial for this matrix is shown in the equation (e40):

(λ−u)(λ³−2uλ²+(u²−a²(1+β))λ−αa²)=0 (e40),

where a=\sqrt{gRhc}, from which the eigenvalues may be calculated numerically.

Finally, the slope term approximation B is defined. This definition of the term exactly preserves the water at rest steady state, which is set forth in equation (e42):

$$B = gR \frac{{h}_{L} {c}_{L} + {h}_{R} {c}_{R}}{2} ( {z}_{R} - {z}_{L} ) . \qquad ( e42 )$$

This definition may break down in certain cases with a wet-dry transition, e.g., when h_{R}=0, h_{L}+z_{L}<z_{R}. In such a case, the velocity of the wet cell is set to zero and the elevation of the high dry cell to the water surface elevation of the wet cell. As a result, for h_{R}=0, h_{L}+z_{L}<z_{R}, u_{L}=0 is set and z_{R}=z_{L}+h_{L} is set. Note that this step is employed only for calculating the fluxes and the relevant source terms.

When multiple sediments are present, the number of waves in the hyperbolic problem increases by one for each additional sediment. In addition, the multiplicity of the wave with speed u also increases by one, which essentially corresponds to the suspended sediment transport for each sediment size or grain size. As such, the problem becomes quickly intractable for large number of sediments if all sediments are handled simultaneously with complete eigenvalue and eigenvector calculations.

In the present techniques, the fluxes for each of the variables are calculated in two distinct steps. In the first step, a series of auxiliary problems is considered in which each sediment type is independently present in the flow with the other sediment sizes being absent. For this problem, which is a single sediment size problem, the wave speeds s_{L}, s_{M}, and s_{R} are computed using the procedure outlined above for the single sediment size problem. Having computed the wave speeds, the intermediate bed elevation states z_{L,i}* and z_{R,i}* are then computed as follows in equation (e43):

$${z}_{L , i}^{*} = \frac{1}{{s}_{M} - {s}_{L}} ( {s}_{M} {z}_{R} {p}_{R , i} - {s}_{L} {z}_{L} {p}_{L , i} + {q}_{L , i} {p}_{L , i} - {q}_{R , i} {p}_{R , i} ) , \\ {z}_{R , i}^{*} = {p}_{R , i} {z}_{R} , \qquad ( e43 )$$

where pᵢ refers to the fraction of the sediment type i in the active layer. Next the intercellular bedload flux for the given sediment size is computed following equation (e19) as below in equation (e44):

F_{ηi}*=1/2(q_{L,i}p_{L,i}+q_{R,i}p_{R,i})+s_{L}(z_{L,i}*−p_{L,i}z_{L})+s_{M}(z_{Ri}*−z_{Li}*) (e44).

The process is then repeated for each sediment type. At the end of the process, the intercellular bedload flux has been computed for all sediment types.

In the second step, the fluxes for the hydrodynamic variables h and hu are computed. For this problem, we consider an average representation of the bed, where the average bed property is obtained by summing over the corresponding property of individual sediment sizes multiplied by its fraction in the active layer. The average bed property we need for this step are the components β̅ and γ̅ of the Jacobian matrix in (e39), and the average bedload flux q̅ (the bar on the top of the variables is supposed to imply an average). These are respectively computed as shown in equations (e45), (e46), and (e47):

$$\begin{matrix}\overline{β} = {Σ}_{i} {p}_{i} \frac{\partial {q}_{i}}{\partial h} , & ( e45 ) \\ \overline{γ} = {Σ}_{i} {p}_{i} \frac{\partial {q}_{i}}{\partial hu} , and & ( e46 ) \\ \overline{q} = {Σ}_{i} {p}_{i} {q}_{i} . & ( e47 )\end{matrix}$$

As before, the wave speeds s_{L}, s_{M} and s_{R} are computed first by using the above values of β̅ and γ̅ in the Jacobian matrix. Having computed the wave speeds, the calculation proceeds as described in (e18) to (e42). By performing these calculations the fluxes for h and hu can be calculated, which can then be used to calculate fluxes for the passively transported variables: hc, hk, and hv. This then concludes the complete calculation of the intercellular flux in a multiple sediment sizes flow problem.

Accordingly, the present techniques may enhance the generation of subsurface models. For example, a method for enhancing hydrocarbon operations for a subsurface region is described. The method may comprise: obtaining a subsurface model of a subsurface region, wherein the subsurface model comprises a plurality of cells and respective cell interfaces are formed between the plurality of cells and comprises a plurality of surfaces; identifying one or more surfaces from the plurality of surfaces within the subsurface model; obtaining paleo-flow data associated with the identified one or more surfaces; determining a simulation model to represent the identified one or more surfaces; determining two or more grain sizes to be modeled in the simulation model; determining a plurality of time steps for a simulation of the paleo-flow that formed the one or more surfaces; simulating paleo-flow with the simulation model to predict the distribution of the two or more grain sizes in the one or more surfaces to predict a grain size distribution in the one or more surfaces; and outputting the grain size distribution in the one or more surfaces from the simulation.

The method may include various enhancements. By way of example, the method may include wherein the paleo-flow data comprises bathymetry data; wherein the paleo-flow data comprises flow conditions at an inlet associated with the identified one or more surfaces; wherein the simulating paleo-flow within the subsurface model further comprises: calculating bedload flux at each of the respective cell interfaces for each of the two or more grain sizes; wherein the simulating paleo-flow with the simulation model further comprises: determining one or more initial conditions for each of the respective cell interfaces, and calculating fluxes at each of the respective cell interfaces; wherein the simulating paleo-flow with the simulation model further comprises: computing one or more wave speeds for each of the two or more grain sizes, and calculating bedload fluxes for each of the respective cell interfaces for each of the two or more grain sizes; wherein the simulating paleo-flow with the simulation model further comprises: calculating hydrodynamic flux for each of the two or more grain sizes for one or more hydrodynamic variables; wherein the simulating the paleo-flow with the simulation model further comprises: computing hydrodynamic wave speeds for each of the two or more grain sizes for one or more hydrodynamic variables with the average properties in a bed in the simulation model; wherein the simulating the paleo-flow with the simulation model further comprises: computing hydrodynamic flux for each of the two or more grain sizes for one or more hydrodynamic variables at the respective cell interfaces; further comprising simulating fluid flow within the subsurface model based on the outputted grain size distributions in the one or more surfaces; further comprising causing a well to be drilled based on the one of the outputted grain size distributions in the one or more surfaces, the output results, the simulated fluid flow, and any combination thereof and/or comprising performing a hydrocarbon operation based on the one of the outputted grain size distributions in the one or more surfaces, the output results, the simulated fluid flow, and any combination thereof.

Also described herein is a system for generating a subsurface model associated with a subsurface region. The system may comprise: a processor; an input device in communication with the processor and configured to receive input data associated with a subsurface region; memory in communication with the processor, the memory having a set of instructions. The set of instructions, when executed by the processor, are configured to: obtain a subsurface model of a subsurface region, wherein the subsurface model comprises a plurality of cells and respective cell interfaces are formed between the plurality of cells and comprises a plurality of surfaces; identify one or more surfaces from the plurality of surfaces within the subsurface model; obtain paleo-flow data associated with the identified one or more surfaces; determine a simulation model to represent the identified one or more surfaces; determine two or more grain sizes to be modeled in the simulation model; determine a plurality of time steps for a simulation of the paleo-flow that formed the one or more surfaces; simulate paleo-flow with the simulation model to predict the distribution of the two or more grain sizes in the one or more surfaces to predict a grain size distribution in the one or more surfaces; and output the grain size distribution in the one or more surfaces from the simulation.

The system may include various enhancements. By way of example, the system may include wherein the set of instructions, when executed by the processor, are configured to: calculate bedload flux at each of the respective cell interfaces for each of the two or more grain sizes; wherein the set of instructions, when executed by the processor, are configured to: determine one or more initial conditions for each of the respective cell interfaces, and calculate fluxes at each of the respective cell interfaces; wherein the set of instructions, when executed by the processor, are configured to: compute one or more wave speeds for each of the two or more grain sizes, and calculate bedload fluxes for each of the respective cell interfaces for each of the two or more grain sizes; wherein the set of instructions, when executed by the processor, are configured to calculate hydrodynamic flux for each of the two or more grain sizes for one or more hydrodynamic variables; wherein the set of instructions, when executed by the processor, are configured to compute hydrodynamic wave speeds for each of the two or more grain sizes for one or more hydrodynamic variables with the average properties in a bed in the simulation model; wherein the set of instructions, when executed by the processor, are configured to: compute hydrodynamic flux for each of the two or more grain sizes for one or more hydrodynamic variables at the respective cell interfaces; and/or wherein the set of instructions, when executed by the processor, are configured to display a notification for a location to drill a well based on the outputted grain size distribution.

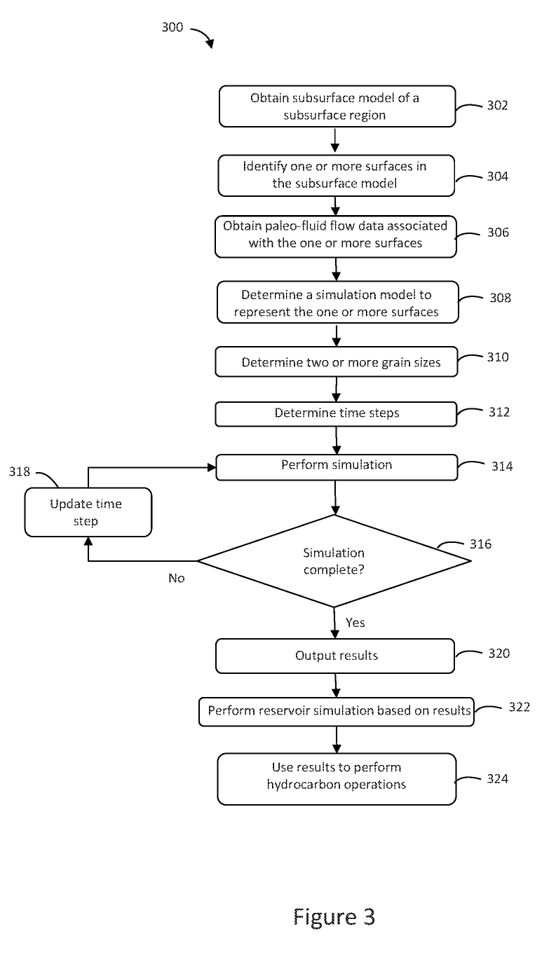

FIG. 3 is an exemplary flow chart 300 in accordance with one or more embodiments of the present techniques. The flow chart 300 includes a method for creating subsurface models that enhance the generation of grain size distribution. The method may include constructing a subsurface model for a subsurface region and using the subsurface model in simulations and in hydrocarbon operations, such as hydrocarbon exploration, hydrocarbon development, and/or hydrocarbon production. The method may include obtaining a simulation model and preparing the simulation model to represent grain size distribution, as shown in blocks 302 to 312. Then, the simulation model is simulated and the results are used to perform simulations and for hydrocarbon operations, as shown in blocks 314 to 324.

To begin, the method may include obtaining a simulation model and preparing the simulation model to represent grain size distribution, as shown in blocks 302 to 312. At block 302, a subsurface model is obtained for the subsurface region. The subsurface model may be created based on measurement data or accessed from memory. The measurement data may include seismic data, resistivity data, gravity data, well log data, core sample data, and combinations thereof. The subsurface model may include geologic features, such as horizons and faults. By way of example, the creation of the subsurface model may include forming a structural framework of objects (e.g., surfaces, such as faults, horizons, and if necessary, additional surfaces that bound the area of interest for the model), verifying or forming the objects into closed volumes, meshing or partitioning the volume into sub-volumes (e.g., cells, mesh elements or voxels) defined by a mesh (e.g., a three dimensional (3D) mesh or 3D grid), and assigning properties to the mesh elements. The properties may include transmissibility, rock type, porosity and/or permeability. At block 304, one or more surfaces are identified in the subsurface model. The one or more surfaces may be identified by determining one or more surfaces that are associated with the formation of reservoir or area of interest, selection or identification of a surface of interest, modeling of surfaces that formed the reservoir or area of interest. By way of example, the identification of one or more surfaces may include identifying paleo-topography associated with one or more surfaces in the subsurface model and reconstructing the paleo topography.

At block 306, paleo-flow data associated with the one or more surfaces is obtained. The paleo-flow data may include bathymetry data from measurement data and/or flow conditions at inlet. The bathymetry data may be obtained from measurement data, such as seismic data. The flow conditions at the inlet may be estimated from known systems, inversion process to determine the inlet conditions. By way of example, the obtaining of paleo-flow data may include identifying the location of the inlet and its characteristics, such as variables h, hu, hv,hk,hc₁,hc₂, . . . hcₙ. At block 308, a simulation model to represent the one or more surfaces is determined. The determination of the simulation model may include determining the paleo topography, deformation the one or more surfaces, reconstructing the paleo topography from the one or more surfaces. The deformation or reconstruction may involve modeling or iterating the model to determine surface at time of deposition. Then, at block 310, two or more grain sizes are determined. The determination of the grain sizes may include determining the grain sizes from core samples, determining the grain sizes from predictions or estimates of the grain sizes, which may be based on other fields or seismic data, or a combination thereof. Then, the grains sizes may be divided into grain size ranges or bins to manage the computational expense of the calculations and simulations. In block 312, the time steps are determined. The determination of the time steps may include dividing the time steps within certain time periods based on the seismic data and/or other measured data. The determination of the time steps may include calculating the time steps from the initial surface and top surface, which may include determining a stopping criterion for the simulation. By way of example, the time steps may be set to be less than the calculation from equation (e17), as noted above.

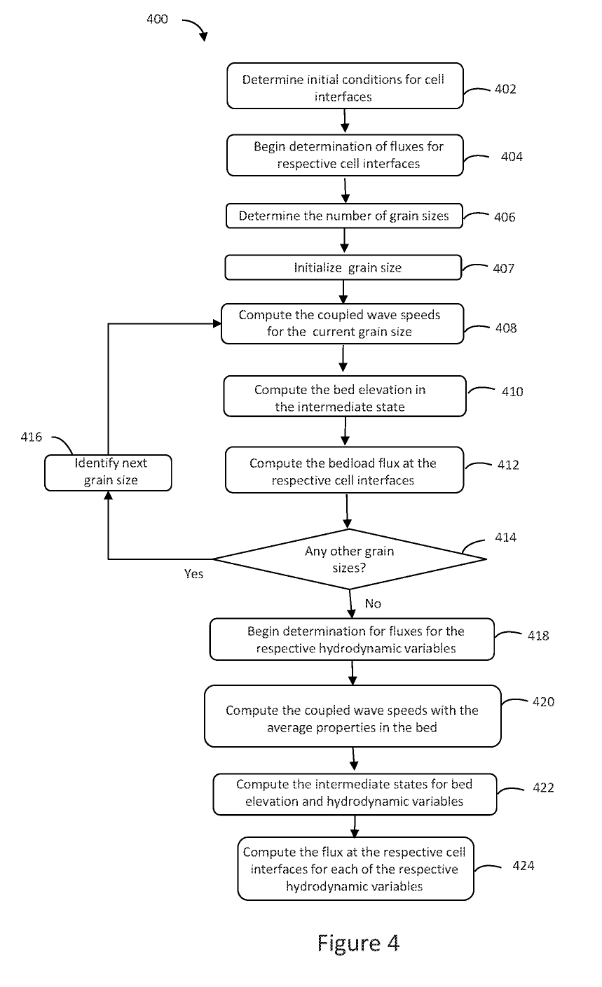

Once the simulation model and settings are obtained, the simulation model is simulated and the results are used to perform simulations and for hydrocarbon operations, as shown in blocks 314 to 324. At block 314, the simulation is performed. The performance of the simulation may include performing the calculations and associated steps noted above and as further described in FIG. 4 below. Then, a determination is made whether the simulation is complete, as shown in block 316. If the simulation is not complete, the time step is updated, as shown in block 318. The updating of the time step may include incrementing the time step. If the simulation is complete, the results may be output, as shown in block 320. The simulation results may be output by displaying the results on a monitor and/or storing the results in memory of a computer system. The results may include the grain size distribution, permeability and/or porosity of the different mesh elements. The output results may be used for drilling exploration or development wells and may also be used for reservoir simulation in production phase.

Then, the results, such as the grain size distribution, permeability and/or porosity are used to perform simulations and/or for hydrocarbon operations, as shown in blocks 322 and 324. At block 322, a simulation may be performed based on the results. The simulation may be performed with the subsurface model, which may have the grain size distribution, permeability and/or porosity incorporated into the respective mesh elements of the subsurface models. The subsurface model may be a reservoir model or a geologic model and may be utilized to provide simulation results. Performing the simulation may include modeling fluid flow based on the reservoir model and the associated properties stored within the cells of the reservoir model. The simulation results may include the computation of time-varying fluid pressure and fluid compositions (e.g., oil, water, and gas saturation) and the prediction of fluid volumes produced or injected at wells. Performing the simulation may also include modeling fluid and/or structural changes based on the subsurface model and the associated properties stored within the mesh elements of the subsurface model. The simulation results may be output by displaying the results on a monitor and/or storing the results in memory of a computer system. The results may include the simulation results, which may include the subsurface model being simulated at each time step or the generated data at each time step, the isomorphic reversible scanning curves and/or heuristics. At block 324, the results, such as simulation results, may be utilized to perform hydrocarbon operations. The hydrocarbon operations may include hydrocarbon exploration operations, hydrocarbon development operations, and/or hydrocarbon production operations. For example, the simulation results and/or the reservoir model may be used to estimate or adjust reserves forecasts, reserves estimations, and/or well performance prediction. As another example, the simulation results and/or the reservoir model may be used to adjust hydrocarbon production operations, such as installing or modifying a well or completion, modifying or adjusting drilling operations and/or installing or modifying a production facility. Further, the results may be utilized to predict hydrocarbon accumulation within the subsurface region; to provide an estimated recovery factor; and/or to determine rates of fluid flow for a subsurface region. The production facility may include one or more units to process and manage the flow of production fluids, such as hydrocarbons and/or water, from the formation.

Beneficially, this method provides an enhancement in the production, development, and/or exploration of hydrocarbons. In particular, the method may be utilized to enhance development of subsurface models that properly characterize fluid flow. Further, the results may provide an enhanced subsurface model with less computational effort, less interactive intervention, and/or in a computationally efficient manner. As a result, this may provide enhancements to production at lower costs and lower risk.

As noted in FIG. 3, the performing the simulation may be further detailed in specific methods. The method may include performing flux calculations for each of the different grain sizes and calculating hydrodynamic variables based on each of the different bedloads associated with different grain sizes. These respective calculations may be performed for each cell interface or pair of interfaces in each time step and then may be performed again for another time step. An exemplary method of calculating the flux calculations and hydrodynamic variable calculations is described in FIG. 4.

By way of example, FIG. 4 is another exemplary flow chart in accordance with one or more embodiments of the present techniques. This method may involve performing flux calculations (e.g., Riemann flux calculations) to generate the intercellular bed load fluxes for each grain size, as shown in blocks 402 to 416, and then determining solutions for the hydrodynamic variables (e.g., generate the intercellular hydrodynamic fluxes for each grain size), as shown in blocks 418 to 424.

To begin, the method involves performing flux calculations (e.g., Riemann flux calculations) for different grain sizes, as shown in blocks 402 to 416. At block 402, the initial conditions for the cell interfaces are determined. The initial conditions may include settings for the respective cells and boundary conditions for the respective cells. The initial conditions may be based on a previous time step and/or may be generated or obtained as initialization settings. The initial conditions may involve specifying the water thickness and/or other parameters. At block 404, the determination of the fluxes are begun for respective cell interfaces. The calculation of the fluxes is performed to generate or yield intercellular bedload fluxes. To calculate the fluxes, the flux pair interfaces may be calculated, which may involve determining the state of left and right cells interfaces. By way of example, the left and right states at the cell interface (W_{L}, W_{R}) are determined, such as flux pairs 110 and 114 or flux pairs 108 and 112 of FIG. 1. The calculations of the flux interfaces may be performed by a pair of cell interfaces. At block 406, the number of grain sizes may be determined. The determination of the number of grain sizes may be performed as noted above in block 310. At block 407, the grain size is initialized. The grain size number may be set to one or another number. The grain size numbers may be based on the different grain size groupings. Then, at block 408, the wave speeds are computed for the current grain size. The computation of the wave speeds, such as wave speeds s_{L}, s_{M} and S_{R}, for the system assuming the fraction of current grain size is equal to one. At block 410, the bed elevation is computed in the intermediate state. The computations for intermediate states are described above, which include the computations associated with equation (e19). At block 412, the bedload flux is computed at the respective cell interfaces. At block 414, a determination is made whether any other grain sizes are to be computed. If another grain size is to be computed, the next grain size is identified, as shown in block 416. This grain size may be incrementing the grain size number. Once the next grain size is identified, the wave speeds are computed for the next grain size, as shown in block 408. If another grain size is not to be computed, the intercellular bed load fluxes for each grain size may be stored or displayed.

Once the intercellular bed load fluxes for each grain size are computed, the solution for the hydrodynamic variables is determined, as shown in blocks 418 to 424. At block 418, the determination of the fluxes for the hydrodynamic variables is begun. The fluxes for each of the hydrodynamic variables may be computed for each grain size, which may be based on the respective bedload flux. The fluxes for each of the hydrodynamic variables may be computed for each cell for the respective grain sizes. The calculations are described above, which are described for example, in the computations associated with equation (e19). These calculations may be used to generate the intercellular hydrodynamic fluxes for each grain size. At block 420, the wave speeds for the respective hydrodynamic variables with the average properties in the bed are computed. The wave speeds for a system is computed with the average properties in the bed in the simulation model. Then, the intermediate states for the bed and the respective hydrodynamic variables are computed, as shown in block 422. Then, at block 424, the flux at the respective cell interfaces for each of the respective hydrodynamic variables is computed. The generated intercellular hydrodynamic fluxes for each grain size may be stored or displayed. Then, as noted above, the intercellular hydrodynamic fluxes for each grain size and intercellular bed load fluxes for each grain size may be used to provide the grain size distribution. The different types of fluxes (e.g., hydrodynamic and bedload) are used to update the cell states using equation (e13). The state of the cell includes the grain size distribution (e.g., deposit thickness for each grain size) along with other variables, such as h, hu, hv, and similar variables.

As may be appreciated, the blocks of FIG. 3 or FIG. 4 may be omitted, repeated, performed in a different order, or augmented with additional steps not shown. Some steps may be performed sequentially, while others may be executed simultaneously or concurrently in parallel.

Persons skilled in the technical field will readily recognize that in practical applications of the disclosed methodology, it is partially performed on a computer, typically a suitably programmed digital computer. Further, some portions of the detailed descriptions which follow are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “processing” or “computing”, “calculating”, “comparing”, “determining”, “displaying”, “copying,” “producing,” “storing,” “adding,” “applying,” “executing,” “maintaining,” “updating,” “creating,” “constructing” “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Embodiments of the present techniques also relate to an apparatus for performing the operations herein. This apparatus may be specially constructed for the required purposes, or it may comprise a general-purpose computer selectively activated or reconfigured by a computer program stored in the computer (e.g., one or more sets of instructions). Such a computer program may be stored in a computer readable medium. A computer-readable medium includes any mechanism for storing or transmitting information in a form readable by a machine (e.g., a computer). For example, but not limited to, a computer-readable (e.g., machine-readable) medium includes a machine (e.g., a computer) readable storage medium (e.g., read only memory (“ROM”), random access memory (“RAM”), magnetic disk storage media, optical storage media, flash memory devices, etc.), and a machine (e.g., computer) readable transmission medium (electrical, optical, acoustical or other form of propagated signals (e.g., carrier waves, infrared signals, digital signals, etc.)).

Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present techniques are in no way limited to implementation in any specific operating system or environment.

By way of example, a simplified representation for subsurface structures is utilized to create subsurface models, which may be used in hydrocarbon operations. Thus, the present techniques may be used to enhance construction of subsurface models, which may be used for hydrocarbon operations and, more particularly, to subsurface modeling. For a subsurface model, a structural framework is created from subsurface measurements. The structural framework may include various objects, such as faults, faults, horizons, and if necessary, one or more surfaces that bound the area of interest. The different objects are meshed to define closed volumes (e.g., zones, compartments, or subvolumes). Then, the closed volumes may be partitioned into small cells defined by the grid. Finally, properties are assigned to cells or objects (e.g., surface transmissibility) and individual cells (e.g., rock type and/or porosity) in the structural framework to form the subsurface model. The subsurface model may be upscaled to perform a simulation.

The present techniques may be utilized to enhance the creation of a subsurface model. The subsurface model, which may include a reservoir model, geomechanical model and/or geologic model, is a computerized representation of a subsurface region based on geophysical and geological observations associated with at least a portion of the specified subsurface region. Subsurface models, such as reservoir models, are typically used as input data for reservoir simulators or reservoir simulation programs that compute predictions for the behavior of rocks and fluids contained within a subsurface region under various scenarios of hydrocarbon recovery. Using subsurface models in simulations provides a mechanism to identify which recovery options offer the most economic, efficient, and effective development plans for a subsurface region (e.g., a particular reservoir and/or field). Accordingly, the generation of the scanning curves may enhance the simulations.

Construction of a subsurface model for a fluid flow simulation is typically a multistep process. Initially, a structural model or structural framework is created from objects (e.g., surfaces, such as faults, horizons, and if necessary, additional surfaces that bound the area of interest for the model). The different objects define closed volumes, which may be referred to as zones, subvolumes, compartments and/or containers. Then, each zone is meshed or partitioned into sub-volumes (e.g., cells, mesh elements or voxels) defined by a mesh (e.g., a 3-D mesh or 3-D grid). Once the partitioning is performed, properties are assigned to objects (e.g., transmissibility) and individual sub-volumes (e.g., rock type, porosity, permeability, rock compressibility, or oil saturation). The objects (e.g., surfaces) are represented as meshes, while the mesh elements form a mesh. Then, the assignment of properties is often also a multistep process where mesh elements are assigned properties. The properties may be assigned in the creation of the subsurface model. For example, properties may include porosity and permeability, which may be based on the grain size distribution determined by the present techniques. Accordingly, the method may include performing the various calculations, as noted above in the various equations and flow charts.

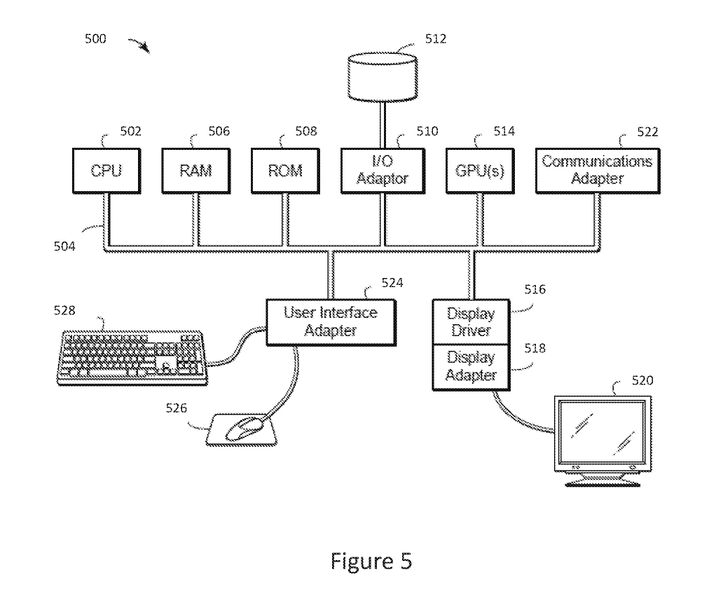

Further, one or more embodiments may include methods that are performed by executing one or more sets of instructions to perform modeling enhancements in various stages. For example, FIG. 5 is a block diagram of a computer system 500 that may be used to perform any of the methods disclosed herein. A central processing unit (CPU) 502 is coupled to system bus 504. The CPU 502 may be any general-purpose CPU, although other types of architectures of CPU 502 (or other components of exemplary system 500) may be used as long as CPU 502 (and other components of system 500) supports the inventive operations as described herein. The CPU 502 may execute the various logical instructions according to disclosed aspects and methodologies. For example, the CPU 502 may execute machine-level instructions for performing processing according to aspects and methodologies disclosed herein.

The computer system 500 may also include computer components such as a random access memory (RAM) 506, which may be SRAM, DRAM, SDRAM, or the like. The computer system 500 may also include read-only memory (ROM) 508, which may be PROM, EPROM, EEPROM, or the like. RAM 506 and ROM 508 hold user and system data and programs, as is known in the art. The computer system 500 may also include an input/output (I/O) adapter 510, a graphical processing unit (GPU) 514, a communications adapter 522, a user interface adapter 524, and a display adapter 518. The I/O adapter 510, the user interface adapter 524, and/or communications adapter 522 may, in certain aspects and techniques, enable a user to interact with computer system 500 to input information.

The I/O adapter 510 preferably connects a storage device(s) 512, such as one or more of hard drive, compact disc (CD) drive, floppy disk drive, tape drive, etc. to computer system 500. The storage device(s) may be used when RAM 506 is insufficient for the memory requirements associated with storing data for operations of embodiments of the present techniques. The data storage of the computer system 500 may be used for storing information and/or other data used or generated as disclosed herein. The communications adapter 522 may couple the computer system 500 to a network (not shown), which may enable information to be input to and/or output from system 500 via the network (for example, a wide-area network, a local-area network, a wireless network, any combination of the foregoing). User interface adapter 524 couples user input devices, such as a keyboard 528, a pointing device 526, and the like, to computer system 500. The display adapter 518 is driven by the CPU 502 to control, through a display driver 516, the display on a display device 520. The subsurface model, simulation results and/or scanning curves may be displayed, according to disclosed aspects and methodologies.

The architecture of system 500 may be varied as desired. For example, any suitable processor-based device may be used, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may use any number of suitable structures capable of executing logical operations according to the embodiments.

As may be appreciated, the method may be implemented in machine-readable logic, such that a set of instructions or code that, when executed, performs the instructions or operations from memory. By way of example, the computer system includes a processor; an input device and memory. The input device is in communication with the processor and is configured to receive input data associated with a subsurface region. The memory is in communication with the processor and the memory has a set of instructions, wherein the set of instructions, when executed, are configured to: obtain a subsurface model of a subsurface region, wherein the subsurface model comprises a plurality of cells and respective cell interfaces are formed between the plurality of cells and comprises a plurality of surfaces; identify one or more surfaces from the plurality of surfaces within the subsurface model; obtain paleo-flow data associated with the identified one or more surfaces; determine a simulation model to represent the identified one or more surfaces; determine two or more grain sizes to be modeled in the simulation model; determine a plurality of time steps for a simulation of the paleo-flow that formed the one or more surfaces; simulate paleo-flow with the simulation model to predict the distribution of the two or more grain sizes in the one or more surfaces to predict a grain size distribution in the one or more surfaces; and output the grain size distribution in the one or more surfaces from the simulation.

In yet other configurations, the set of instructions, when executed by the processor, may be configured to: calculate bedload flux at each of the respective cell interfaces for each of the two or more grain sizes; determine one or more initial conditions for each of the respective cell interfaces, and calculate fluxes at each of the respective cell interfaces; compute one or more wave speeds for each of the two or more grain sizes, and calculate bedload fluxes for each of the respective cell interfaces for each of the two or more grain sizes; calculate hydrodynamic flux for each of the two or more grain sizes for one or more hydrodynamic variables; compute hydrodynamic wave speeds for each of the two or more grain sizes for one or more hydrodynamic variables with the average properties in a bed in the simulation model; compute hydrodynamic flux for each of the two or more grain sizes for one or more hydrodynamic variables at the respective cell interfaces; and/or display a notification for a location to drill a well based on the outputted grain size distribution.

It should be understood that the preceding is merely a detailed description of specific embodiments of the invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents. It is also contemplated that structures and features embodied in the present examples can be altered, rearranged, substituted, deleted, duplicated, combined, or added to each other. As such, it will be apparent, however, to one skilled in the art, that many modifications and variations to the embodiments described herein are possible. All such modifications and variations are intended to be within the scope of the present invention, as defined by the appended claims.

1. A method for enhancing hydrocarbon operations for a subsurface region comprising:
obtaining a subsurface model of a subsurface region, wherein the subsurface model comprises a plurality of cells and respective cell interfaces are formed between the plurality of cells and comprises a plurality of surfaces;
identifying one or more surfaces from the plurality of surfaces within the subsurface model;
obtaining paleo-flow data associated with the identified one or more surfaces;
determining a simulation model to represent the identified one or more surfaces;
determining two or more grain sizes to be modeled in the simulation model;
determining a plurality of time steps for a simulation of the paleo-flow that formed the one or more surfaces;
simulating paleo-flow with the simulation model to predict the distribution of the two or more grain sizes in the one or more surfaces to predict a grain size distribution in the one or more surfaces; and
outputting the grain size distribution in the one or more surfaces from the simulation.

2. The method of claim 1, wherein the paleo-flow data comprises bathymetry data.

3. The method of claim 1, wherein the paleo-flow data comprises flow conditions at an inlet associated with the identified one or more surfaces.

4. The method of claim 1, wherein the simulating paleo-flow within the subsurface model further comprises: calculating bedload flux at each of the respective cell interfaces for each of the two or more grain sizes.

5. The method of claim 4, wherein the simulating paleo-flow with the simulation model further comprises:
determining one or more initial conditions for each of the respective cell interfaces; and
calculating fluxes at each of the respective cell interfaces.

6. The method of claim 4, wherein the simulating paleo-flow with the simulation model further comprises:
computing one or more wave speeds for each of the two or more grain sizes; and
calculating bedload fluxes for each of the respective cell interfaces for each of the two or more grain sizes.

7. The method of claim 1, wherein the simulating paleo-flow with the simulation model further comprises: calculating hydrodynamic flux for each of the two or more grain sizes for one or more hydrodynamic variables.

8. The method of claim 1, wherein the simulating the paleo-flow with the simulation model further comprises: computing hydrodynamic wave speeds for each of the two or more grain sizes for one or more hydrodynamic variables with the average properties in a bed in the simulation model.

9. The method of claim 1, wherein the simulating the paleo-flow with the simulation model further comprises: computing hydrodynamic flux for each of the two or more grain sizes for one or more hydrodynamic variables at the respective cell interfaces.

10. The method of claim 1, further comprising simulating fluid flow within the subsurface model based on the outputted grain size distributions in the one or more surfaces.

11. The method of claim 1, further comprising causing a well to be drilled based on the one of the outputted grain size distributions in the one or more surfaces, the output results, the simulated fluid flow, and any combination thereof.

12. The method of claim 1, comprising performing a hydrocarbon operation based on the one of the outputted grain size distributions in the one or more surfaces, the output results, the simulated fluid flow, and any combination thereof.

13. A system for generating a subsurface model associated with a subsurface region, comprising:
a processor;
an input device in communication with the processor and configured to receive input data associated with a subsurface region;
memory in communication with the processor, the memory having a set of instructions, wherein the set of instructions, when executed by the processor, are configured to:
obtain a subsurface model of a subsurface region, wherein the subsurface model comprises a plurality of cells and respective cell interfaces are formed between the plurality of cells and comprises a plurality of surfaces;
identify one or more surfaces from the plurality of surfaces within the subsurface model;
obtain paleo-flow data associated with the identified one or more surfaces;
determine a simulation model to represent the identified one or more surfaces;
determine two or more grain sizes to be modeled in the simulation model;
determine a plurality of time steps for a simulation of the paleo-flow that formed the one or more surfaces;
simulate paleo-flow with the simulation model to predict the distribution of the two or more grain sizes in the one or more surfaces to predict a grain size distribution in the one or more surfaces; and
output the grain size distribution in the one or more surfaces from the simulation.

14. The system of claim 13, wherein the set of instructions, when executed by the processor, are configured to: calculate bedload flux at each of the respective cell interfaces for each of the two or more grain sizes.

15. The system of claim 14, wherein the set of instructions, when executed by the processor, are configured to:
determine one or more initial conditions for each of the respective cell interfaces; and
calculate fluxes at each of the respective cell interfaces.

16. The system of claim 14, wherein the set of instructions, when executed by the processor, are configured to:
compute one or more wave speeds for each of the two or more grain sizes; and
calculate bedload fluxes for each of the respective cell interfaces for each of the two or more grain sizes.

17. The system of claim 13, wherein the set of instructions, when executed by the processor, are configured to calculate hydrodynamic flux for each of the two or more grain sizes for one or more hydrodynamic variables.

18. The system of claim 13, wherein the set of instructions, when executed by the processor, are configured to compute hydrodynamic wave speeds for each of the two or more grain sizes for one or more hydrodynamic variables with the average properties in a bed in the simulation model.

19. The system of claim 13, wherein the set of instructions, when executed by the processor, are configured to: compute hydrodynamic flux for each of the two or more grain sizes for one or more hydrodynamic variables at the respective cell interfaces.

20. The system of claim 13, wherein the set of instructions, when executed by the processor, are configured to display a notification for a location to drill a well based on the outputted grain size distribution.
